(19) United States
(12) Patent Application Publication
(10) Pub. No.: US 2006/0014506 A1
(43) Pub. Date: Jan. 19, 2006

(54) Dynamic carrier selection and link adaptation in fading environments

(76) Inventor: Jacobus C. Haartsen, Hardenberg (NL)

Correspondence Address: POTOMAC PATENT GROUP, PLLC, P. O. BOX 270, FREDERICKSBURG, VA, 22404, US

(21) Appl. No.: 10/893,305

(22) Filed: Jul. 19, 2004

(51) Int. Cl. H04B 17/00; H04B 1/16; H04B 7/00

(52) U.S. Cl. 455/227; 455/517; 455/226.4

(57) ABSTRACT

A channel response of a channel in a dual-mode radio communication system is determined by detecting a wideband signal and using a narrowband receiver to generate received signal strength measurements at frequencies located within a bandwidth of the wideband signal. The wideband signal need not be intended for reception by the radio unit that detected it and generated the received signal strength measurements therefrom. The received signal strength measurements are used as an indicator of the channel response of the channel. Based on the indicator of the channel response, a modulation scheme may be selected. The indicator of the channel response of the channel may also be used to determine an adjustment of a center frequency of the wideband signal.

### BACKGROUND

This invention relates generally to communications in which total available spectral bandwidth is larger than that needed for communication and, more particularly, to optimization of communication systems in which communicating devices are allowed to change carriers in order to make use of excess available bandwidth. Furthermore, the invention relates to wireless channels that are impacted by multi-path conditions giving rise to large signal strength variations in the frequency domain.

In wireless communication systems, data to be communicated is typically transmitted in bursts on a carrier whose characteristics may vary over time. In other words, a first burst of data might be transmitted over the carrier while the carrier has very good performance that allows the first burst of data to be received correctly, while, as a second burst of data is transmitted on the carrier, the performance of the carrier might have worsened such that the second burst of data is not received correctly. This problem can be explained by the fact that the channel includes multiple paths between the transmitter and the receiver; therefore, even a small movement by either a transmitter or a receiver can affect whether these multiple paths combine constructively or destructively.

If a rate of change of the performance of a carrier is relatively great in comparison to a data rate on the carrier, the problem of varying carrier performance can be solved using coding and interleaving, in which carrier performance variations are averaged so that the carrier's performance depends on average carrier conditions rather than on worst-case carrier conditions. However, if the carrier's performance varies relatively slowly and/or if the data rate is relatively great, this approach is not feasible because the number of symbols needed in an interleaver is too large. In such situations, an entire packet could be received during a period in which the carrier's performance is poor.

Multi-path phenomena are frequency-selective; therefore, if performance of a first carrier having a first frequency is poor, performance of a second carrier having a second frequency is often better, especially if the second frequency is not too close to the first frequency. The coherence bandwidth is a measure of how far apart the two frequencies must be in order for the two carriers to be uncorrelated.

Reference is now made to FIG. 1, wherein there is shown a graph representing an exemplary frequency response 104 of a channel in the 2.4 GHz unlicensed Industrial Scientific and Medical (ISM) radiofrequency band. Graph 100 shows frequency, in Megahertz (MHz), plotted on an x-axis and signal strength, plotted in decibels (dB) (i.e., 20 log [abs (H(f))]), plotted on a y-axis. The graph 100 only shows the part from 2400 MHz to 2440 MHz. In practice, the entire 2.4 GHz ISM band from 2400 MHz to 2483.5 MHz is available, but for the sake of clarity, only the lower part is shown here. The spectral representation of the signal is shown as the transmission spectrum 102. As an example in FIG. 1, the transmission spectrum 102 is placed at 2415 MHz. In this area, the channel response 104 is fairly flat and shows low attenuation. The signal 102 would have worse performance when placed at 2406 MHz, for example, where there is a fading dip in the spectrum. The channel of FIG. 1 has a coherence bandwidth of about 10 MHz.

One way of communicating over a frequency-selective carrier is by means of frequency hopping (FH), which is used, for example, in the BLUETOOTH® wireless technology system. See, e.g., J. C. Haartsen, “The Bluetooth radio system,” IEEE Personal Communications, Vol. 7, No. 1, February 2000. In the BLUETOOTH® wireless technology system, which is an ad-hoc system that operates in the unlicensed ISM band at 2.4 GHz, one of the reasons for employing FH over 79 1-MHz-wide carriers is to avoid transmitting on a single carrier that could be strongly attenuated for a long time period due to multi-path fading. Another reason for using FH is to have a system that is robust in the presence of interference from other users as well as from other impairments.

Frequency hopping is a way of averaging quality of the total available bandwidth, and, in situations in which the carrier performance changes rapidly, FH often provides best-case real-world performance. However, in situations in which a portion of the bandwidth changes slowly, it would be desirable to further improve performance. For example, if a part of the bandwidth is disturbed by an almost static interferer, this part of the bandwidth should typically be avoided. A static interferer could, for example, be a switched-on microwave oven, since many microwave ovens use part of the ISM band.

Carriers that are operating in a part of the bandwidth that is disturbed by almost-static interferer(s) should be avoided. A procedure for selecting suitable carriers that are not affected by the almost-static interferer(s) would be desirable.

In addition, it is clear from FIG. 1 that regions of the frequency spectrum where the signal strength is low or varying considerably should be avoided as well. Destructive multi-path conditions give rise to additional attenuation in specific frequency regions. In order to achieve acceptable performance, the output power of the transmitter needs to be increased to compensate for the additional loss. Moreover, if the signal bandwidth 106 of the transmission spectrum 102 is large with respect to the variations in the channel frequency response (e.g., the signal bandwidth 106 encompasses several fading dips), severe distortion of the signal results. This is because the delay difference between the different multi-paths is so large, with respect to the symbol time, that symbols arriving from different paths interfere with one another. This self interference is also referred to as Inter Symbol Interference or ISI.

Crucial for a system that dynamically determines which carrier to use is channel assessment. In the channel assessment scheme, the transceiver has to judge whether the considered carrier has both low interference conditions and a flat fading response. The latter becomes more important when a wider signal bandwidth with more complex modulation schemes is used. Interference can be measured by merely scanning a specific frequency band. No transmission is required from the associated transmitter. In contrast, the channel response can be measured only when the transmitter sends a signal with known characteristics.

U.S. patent application Ser. No. 09/894,050 (henceforth “the '050 application”), filed on Jun. 28, 2001 and entitled “Method and System for Dynamic Carrier Selection”, is hereby incorporated herein by reference. The '050 application, which has also been published as International Publication Number WO 02/37692 A2 on May 10, 2002, describes a system for applying dynamic carrier selection in a high-speed mode of BLUETOOTH®. In the basic mode providing data rates up to 3 Mb/s, the BLUETOOTH® technology applies frequency hopping; in the high-speed (HS) mode providing data rates up to 12 Mb/s, the BLUETOOTH® technology applies dynamic carrier selection (DCS) of a static carrier which can be placed at 77 different positions in the 2.4 GHz ISM band. In the '050 application, a method is presented in which the receiver, operating in HS mode, regularly scans the ISM band to check for interference. In addition, when in the FH mode, the transceiver assesses the attenuation of the channel by carrying out RSSI measurements. To do this, the transceiver returns to the FH mode in order to take channel response measurements. More specifically, the transceiver monitors the narrow-band transmissions of other transmitters operating in a frequency hopping mode. These various measurements are collected and together used to identify fading dips in the frequency spectrum.

It is therefore desirable to provide methods and systems for assessing the quality of a wideband channel. It is also desirable to provide methods and systems that direct the DCS to a new carrier when the carrier's performance varies due to interference and due to multi-path phenomena. In addition, there is a desire for methods and apparatuses that enable selection between modulation formats in a wideband communication system based on channel conditions.

### SUMMARY

It should be emphasized that the terms “comprises” and “comprising”, when used in this specification, are taken to specify the presence of stated features, integers, steps or components; but the use of these terms does not preclude the presence or addition of one or more other features, integers, steps, components or groups thereof.

In accordance with one aspect of the present invention, the foregoing and other objects are achieved in methods, apparatuses and systems that determine a channel response of a channel in a dual-mode radio communication system. In one aspect, a wideband signal is detected. In some embodiments, the wideband signal is not intended for reception by the receiver performing this detection. In alternative embodiments, the wideband signal may be intended for reception by the receiver performing this detection. In all embodiments, however, a narrowband receiver is used to generate received signal strength measurements at frequencies located within a bandwidth of the wideband signal. The received signal strength measurements are used as an indicator of the channel response of the channel.

In another aspect, a modulation scheme is selected based on the indicator of the channel response of the channel. This selection may be performed in a radio unit that performed detecting the wideband signal. Alternatively, the received signal strength measurements (or information about them) may be communicated to a radio unit that transmitted the wideband signal, which radio unit then selects the modulation scheme based on the indicator of the channel response of the channel.

In yet other alternatives, instead of communicating the received signal strength measurements to the radio unit that transmitted the wideband signal, one or more parameters may be generated that represent a flatness of the wideband signal. These parameters may then be communicated to the radio unit that transmitted the wideband signal, where it may serve as a basis for selecting a suitable modulation scheme.

In yet other alternatives control logic may determine how to adjust a center frequency of the wideband signal based on the indicator of the channel response of the channel, or any other equivalent parameters made available to the control logic.

In embodiments in which the wideband signal is intended for reception by the radio unit performing the wideband signal detection and received signal strength measuring, the radio unit, while using the narrowband receiver to generate received signal strength measurements at frequencies located within the bandwidth of the wideband signal, also uses a wideband receiver to demodulate the wideband signal.

### BRIEF DESCRIPTION OF THE DRAWINGS

The objects and advantages of the invention will be understood by reading the following detailed description in conjunction with the drawings in which:

FIG. 1 is a graph that illustrates an exemplary channel response as a function of frequency ranging from 2400 to 2440 MHz, and an exemplary wideband transmission spectrum having a center frequency within that same frequency range.

FIG. 2 is a diagram that illustrates a plurality of exemplary carriers of a system operating in accordance with an aspect of the invention.

FIG. 3 is a graph of a transmit spectrum of the high-speed mode.

FIG. 4 is a scenario with two high-speed slaves connected with a master in a personal or local area network.

FIG. 5 is a timing diagram showing the activity of the master and slaves according to an exemplary embodiment.

FIG. 6 is a timing diagram showing the activity of the master and slaves according to an alternative exemplary embodiment.

FIG. 7 is an example of RSSI measurement results according to an exemplary embodiment of this application.

FIG. 8 is an example of a derived channel response according to an exemplary embodiment.

FIG. 9 is another example of another derived channel response according to an exemplary embodiment.

FIG. 10 is a radio receiver according to an exemplary embodiment.

FIG. 11 is a radio receiver according to another exemplary embodiment.

FIG. 12 is a radio receiver according to yet another exemplary embodiment.

### DETAILED DESCRIPTION

The various features of the invention will now be described in connection with exemplary embodiments with reference to the figures, in which like parts are identified with the same reference characters.

To facilitate an understanding of the invention, many aspects of the invention are described in terms of sequences of actions to be performed by elements of a computer system. It will be recognized that in each of the embodiments, the various actions could be performed by specialized circuits (e.g., analog circuitry and/or discrete logic gates interconnected to perform a specialized function), by program instructions being executed by one or more processors, or by a combination of both. Moreover, the invention can additionally be considered to be embodied entirely within any form of computer readable carrier, such as solid-state memory, magnetic disk, optical disk or carrier wave (such as radio frequency, audio frequency or optical frequency carrier waves) containing an appropriate set of computer instructions that would cause a processor to carry out the techniques described herein. Thus, the various aspects of the invention may be embodied in many different forms, and all such forms are contemplated to be within the scope of the invention. For each of the various aspects of the invention, any such form of embodiments may be referred to herein as “logic configured to” perform a described action, or alternatively as “logic that” performs a described action.

If carrier performance changes slowly, it would be desirable to measure the quality of an entire available bandwidth. Measurement of the entire available bandwidth reveals whether there are any parts of the bandwidth that should be avoided because of the presence of static interference and also shows which parts of the bandwidth are performing well and which are performing poorly due to frequency-selective fading. A system that can exploit information about the latter has been described in U.S. Pat. No. 6,519,460 (“Resource management in uncoordinated frequency hopping system,”), which issued on Feb. 11, 2003 and which is hereby incorporated herein by reference. The just-mentioned U.S. Pat. No. 6,519,460 describes a high-speed (HS) mode that can be incorporated in, for example, the BLUETOOTH® wireless technology system.

A HS carrier operating according to the HS mode is based on a dynamic carrier selection (DCS) algorithm rather than on frequency hopping (FH). With DCS, carriers in the available bandwidth that are attractive both from a propagation (i.e., fading) and from an interference (i.e., low disturbance) point of view are selected.

The DCS algorithm involves collection of information via measurement of a frequency spectrum. Of course, measuring the entire available bandwidth in such a way that non-static interference (e.g., signals from hopping BLUETOOTH® wireless technology units) is averaged out can take some time; therefore, such measurements should not be taken unless necessary. It is advantageous for the measurements to be taken at the same time that data is transmitted, so that neither the carrier spectrum nor time is wasted by measurements being taken alone. In particular, since at least two units must be involved in a communication, one way of reducing the time needed for taking measurements is to have several units take carrier measurements and then combine the measured values. In this way, the same number of measurements can be taken in a shorter period of time than if only one unit was taking measurements.

To facilitate describing the various exemplary embodiments, examples herein are based on a system operating according to the BLUETOOTH® wireless technology system (See, e.g., J. C. Haartsen, “The Bluetooth radio system,” IEEE Personal Communications, Vol. 7, No. 1, February 2000) and according to the high-speed mode as described in the above-referenced U.S. Pat. No. 6,519,460. The BLUETOOTH® wireless technology system applies a 1-MHz-wide FH carrier that uses a pseudo-random FH sequence spanning the entire Industrial, Scientific, and Medical (ISM) band, whereas the high-speed carrier uses a semi-fixed, approximately 4 to 5 MHz-wide signal (at −3 dB) that employs dynamic carrier selection (DCS). It is assumed that the BLUETOOTH® wireless technology is the fall-back mode of the system.

Referring again to the figures, FIG. 2 is a diagram that illustrates a plurality of exemplary carriers of a system operating in accordance with the present invention. Carriers 0-76 are illustrated in a range from 2.4-2.4835 GHz, the carriers 0, 1, 2, 3, 75, and 76 being explicitly shown. The number of carriers depends on the available bandwidth and other system parameters. In FIG. 2, a given carrier is separated by 1 MHz from adjacent carriers (e.g., the carrier 1 operates at 2.404 GHz, while the carriers 0 and 2 operate at 2.403 GHz and 2.405 GHz, respectively). As should be apparent to those skilled in the art, the present invention is not restricted to a system based on the BLUETOOTH® wireless technology system, but, with appropriate modifications, can be used with other systems as well.

In an exemplary embodiment of the invention, the HS mode can be viewed as an extension mode of the BLUETOOTH wireless technology system that can, for example, be entered into for a limited time when a higher data rate is desired. One such scenario could be when a large file is sent from a laptop computer to a printer. Another scenario could be communication of streaming video. A more detailed description of this mode can be found in the above-cited U.S. Pat. No. 6,519,460.

In a more advanced system, the HS mode will support different data rates which can be engaged depending on the channel conditions. For example, a robust Differential Binary Phase Shift Keying (DBPSK) scheme can be applied when conditions (fading and or noise/interference) are poor; a Differential Quadrature Phase Shift Keying (DQPSK) scheme can be used under medium channel conditions, and an 8-symbol Phase Shift Keying (8-PSK) scheme can be used under good channel conditions. For the remainder of the disclosure, a symbol rate of 4 Msymbols/s is assumed. With proper signal shaping, this gives a signal bandwidth 106 on the order of 4 to 5 MHz at −3 dB. At this symbol rate, the DBPSK mode will support 4 Mb/s, the QPSK mode will support 8 Mb/s, and the 8-PSK mode will support 12 Mb/s. Techniques for determining interference conditions can be found, for example, in the above-referenced U.S. patent application Ser. No. 09/894,050. Yet, the modulation scheme is very much dependent on the channel response: higher modulation schemes require a flatter channel response in order to maintain the linearity conditions. To apply link adaptation, proper knowledge of the channel response is desirable. One could of course just try different modulation schemes and assess the performance based on Packet Error Rate (PER) and Bit Error Rate (BER). However, this may take quite some time before statistical reliability is obtained. Moreover, once the channel is found to perform badly, there is no indication how the center frequency of the channel should be moved (i.e., in the frequency domain) in order to provide acceptable conditions.

In U.S. patent application Ser. No. 09/894,050, the attenuation is determined by measuring the RSSI when the units are communicating in the FH mode. As the units are hopping through their usually pseudo-random frequency hop sequence, sufficient measurements must be collected from the FH carriers that are within the transmission spectrum 102 of the HS signal to be of use in the link adaptation scheme of the HS system. Alternatively, RSSI measurements could be taken in the HS mode to reveal the attenuation conditions in the signal bandwidth 106. However, these RSSI measurements are carried out in a rather wide frequency bandwidth of the HS receiver, corresponding to the bandwidth of the HS channel. For the 4 to 5 MHz channel (at −3 dB), this means that the resolution of the measurements is worse than 4 MHz. With these measurements, it is not possible to determine whether the channel response is flat in the bandwidth of interest (i.e. occupied by the transmission spectrum 102).

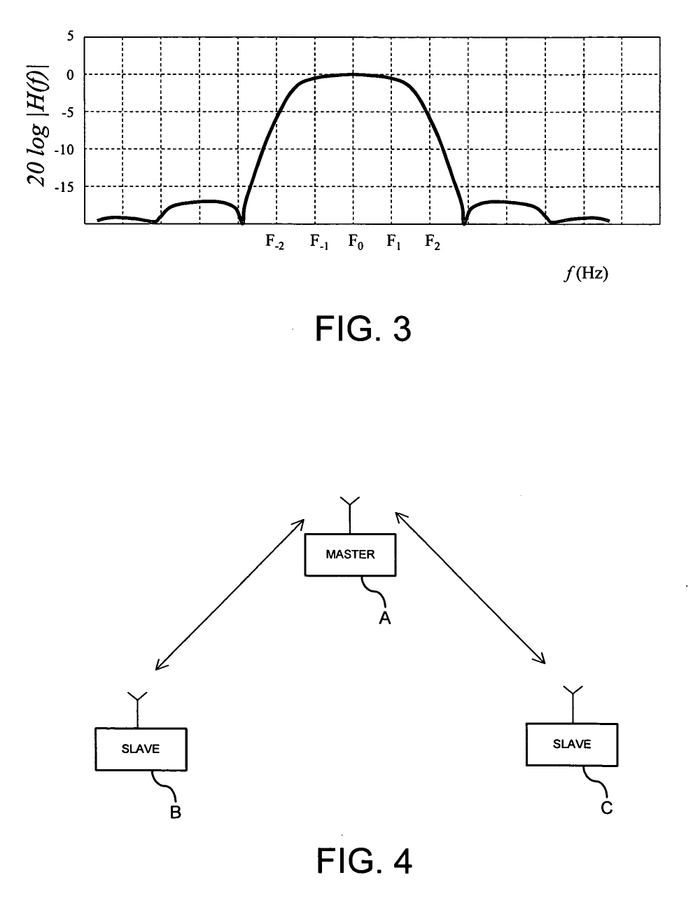

Accordingly, it is a purpose of this disclosure to present methods and apparatuses for determining the channel response in the band of interest with a finer resolution. In one aspect, this is achieved by using the FH receiver on the HS channel. In the U.S. Pat. No. 6,519,460, a dual-mode radio transceiver is described. This transceiver has a narrowband receiver (e.g., a receiver bandwidth of about 500 kHz at −3 dB) for supporting the FH mode, and a wideband receiver (about 5 MHz receiver bandwidth) for supporting the HS mode. The transmit spectrum of a wideband transmitter is shown in FIG. 3, in which divisions on the horizontal axis are spaced 1 MHz apart. Note that it encompasses about five 1 MHz spaced carriers. In an aspect of the invention, the narrowband receiver of one unit is active to measure RSSI while HS signals are sent by another unit. These HS signals may be intended for a receiver different from the measuring receiver, or alternatively may be intended for the same receiver. Thus, the narrowband receiver carries out measurements on one or more transmissions taking place on the HS channel. By tuning to different consecutive carriers, spaced at, for example, 1 MHz, an indication of the frequency response of the channel is obtained. By taking into account the signal strength fall off at the band edges, the channel response at the boundaries of the signal bandwidth of interest can also be determined.

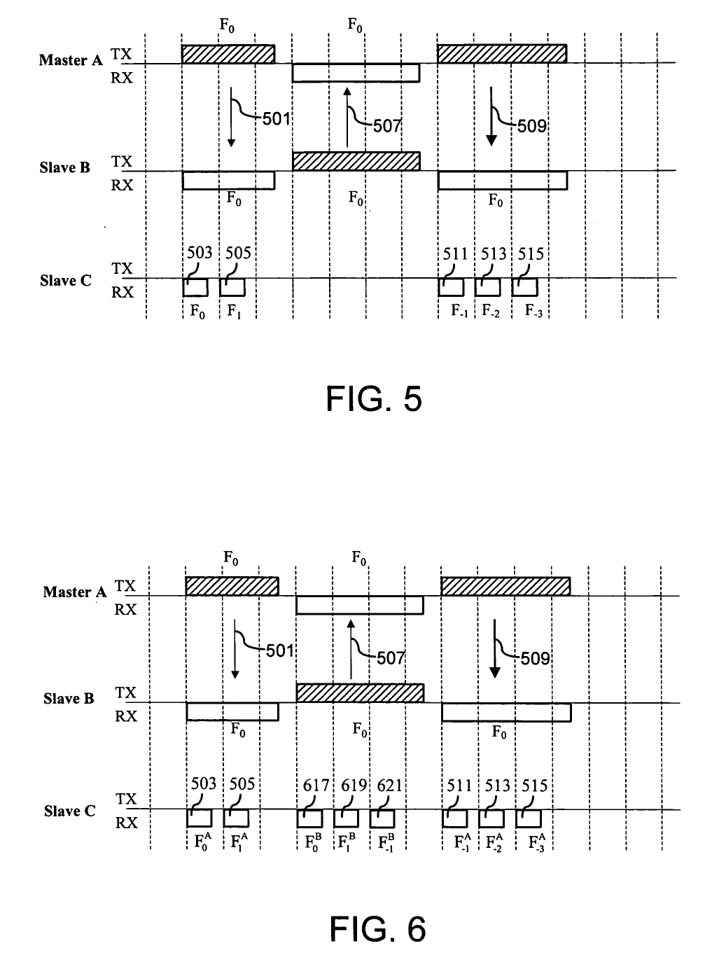

The scheme is exemplified by FIGS. 4 and 5. In FIG. 4, a master A with two slaves B and C are shown. All units include a dual-mode transceiver with a narrowband radio for supporting the FH mode and a broadband radio for supporting the HS mode. Referring now to the timing/process diagram of FIG. 5, while the master A transmits (501) a packet to one slave B via the HS channel (i.e. using the transmit spectrum as shown in FIG. 3 and centered at carrier F₀), the other slave C measures (503, 505) the RSSI using its narrowband receiver, tuned to one of the 1 MHz-spaced carriers F₋₂, F₋₁, F₀, F₁, F₂ . . . in the HS channel. (In the example, slave C measures (503, 505) the RSSI on carriers F₀, F₁, although this is by no means essential.) Following master A's transmission (501) to slave B, slave B responds with its own HS wideband transmission (507) intended for master A. In this exemplary embodiment, slave C is concerned only with the channel conditions between itself and master A, and so ignores slave B's transmission. Following this, master A again transmits (509) a packet to slave B via the HS channel (i.e. using the transmit spectrum as shown in FIG. 3 and centered at carrier F₀), during which time slave C again measures (511, 513, 515) the RSSI using its narrowband receiver, this time tuned to carriers F₋₁, F₋₂, F₋₃, respectively. The process would continue in this fashion until slave C has accumulated RSSI measurements for all of the relevant narrowband carriers included within the wideband HS channel between the master A and itself.

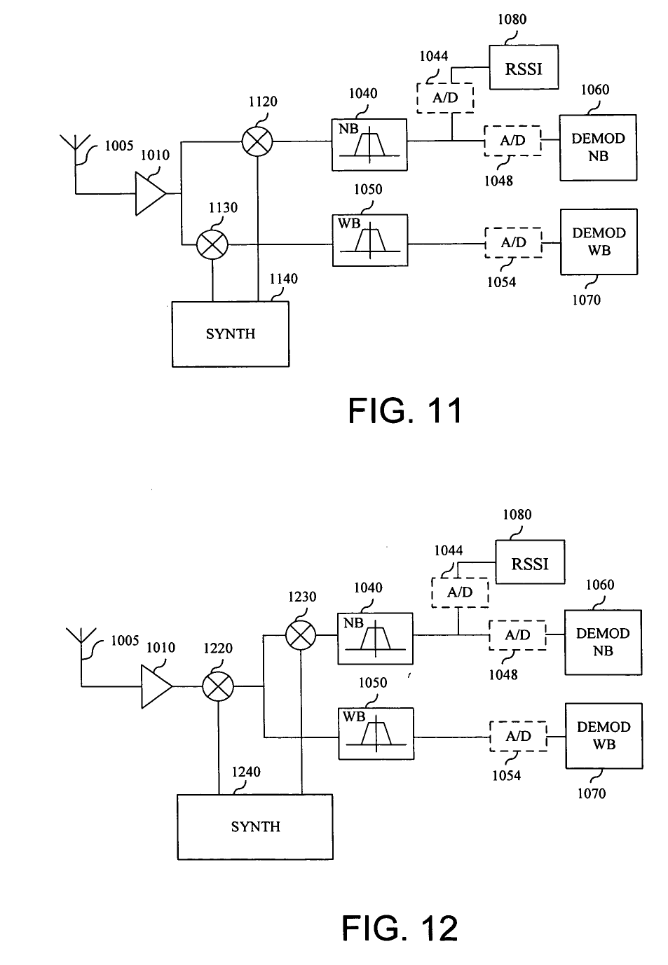

In one alternative embodiment, the receiver within a unit, such as the slave C, is capable of taking narrowband RSSI measurements on the HS packet while at the same time demodulating the HS packet. Consequently, the slave C in this embodiment is capable of determining the necessary measurements from HS transmissions in which it (i.e., slave C) is the intended recipient. A receiver architecture with this capability is described in greater detail later with reference to FIG. 11.

In another aspect of the invention, described now with reference to the timing/process diagram of FIG. 6, the slave C is capable of determining channel conditions between itself and the master A, and so performs the same actions as described above with respect to FIG. 5. Additionally, however, the slave C is interested in determining the conditions of the channel between itself and slave B, in the event that slave B should at some point begin transmitting to slave C. Thus, in addition to the already-described steps 501, . . . ,515, slave C additionally measures (617, 619, 621) the RSSI using its narrowband receiver, this time tuned to respective carriers F^{B}₀, F^{B}₋₁, F^{B}₋₁, included within the wideband HS channel between slave B and itself. Here, as well as in FIG. 6, the superscript “A” is used to denote a carrier within the wideband HS channel between master A and slave C, whereas the superscript “B” is used to denote a carrier within the wideband HS channel between slave B and slave C. The process would continue in this fashion until slave C has accumulated RSSI measurements for all of the relevant narrowband carriers included within the wideband HS channel between slave B and slave C. The slave C would store these measurements for later use in the event that it begins receiving transmissions from the slave B. It should be emphasized that the measurements made by slave C on master A's transmissions are kept separate from the measurements made by slave C on slave B's transmissions—they are not combined.

In another aspect of the invention, the functional relationship between the collected RSSI measurements and the carrier frequency, possibly compensated by variations in the transmit spectrum (in particular at the band edges) gives a good indication of the “flatness” of the channel. This flatness can indicate whether higher modulation schemes like QPSK or 8-PSK can be supported. Moreover, if variations in the channel frequency response are found, the measurements can indicate how the transmission spectrum 102 should be shifted (to higher or lower frequencies) in order to provide flatter channel conditions.

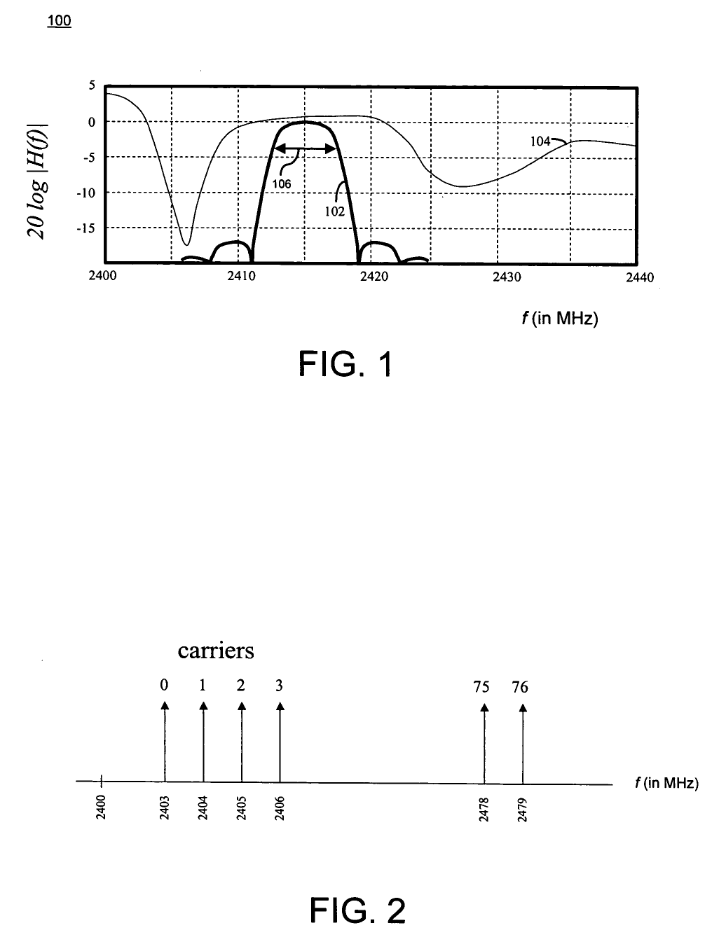

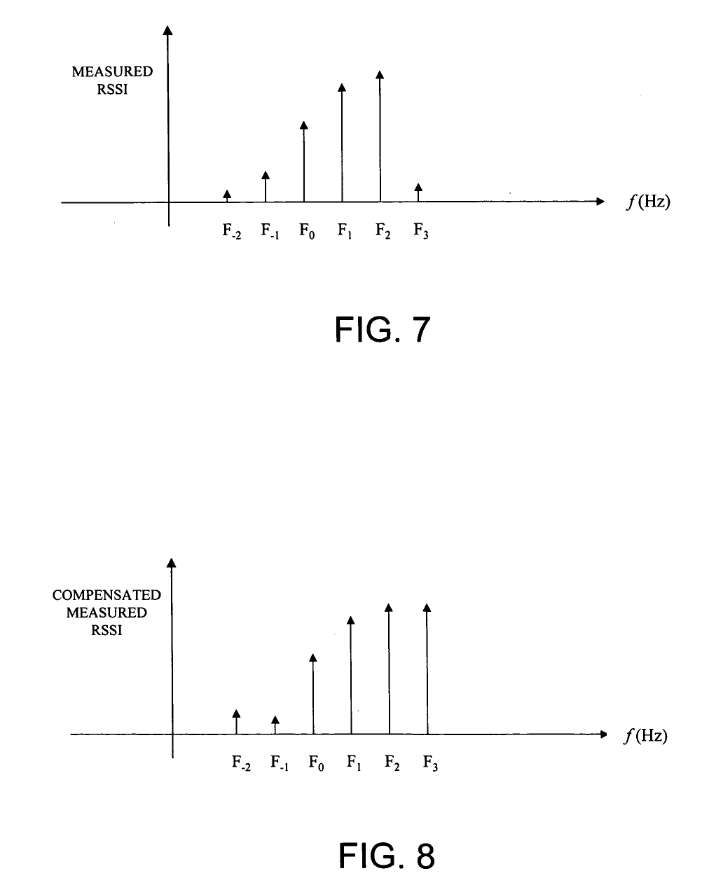

For example, assume that slave C's channel conditions are those depicted as the exemplary frequency response 104 in FIG. 1, and further assume that the HS channel is centered at 2407 MHz. FIG. 7 is a graph showing the RSSI values measured in slave A before compensation, as a function of narrowband frequency. The transmission (TX) (known) spectrum was shown in FIG. 3. A graph of the compensated RSSI measurement values as a function of narrowband frequency is shown in FIG. 8. The result of considering this function is the channel response for the wideband channel centered at F₀. The slave C can report the RSSI values to the master A for the master A's DCS to use in making decisions concerning what modulation scheme to use and/or whether to change to a different wideband HS channel (i.e., one centered at a different frequency than is presently being used).

In alternative embodiments, the slave C can itself use the collected RSSI values to determine one or more parameters representing the flatness of the wideband HS channel and communicate these parameters to the master A for the master A's DCS to use in making decisions concerning what modulation scheme to use and/or whether to change to a different wideband HS channel.

In still other alternative embodiments, the slave C can itself use the collected RSSI values to determine the flatness of the wideband HS channel and then itself determine what modulation scheme to use. The slave C's choice of modulation scheme can then be communicated to the master A.

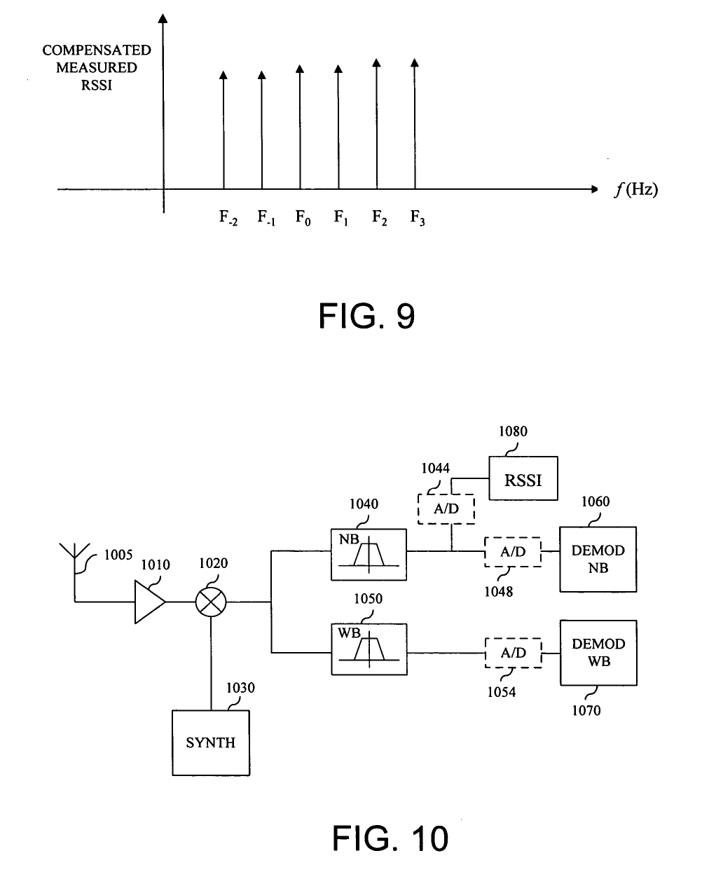

The channel response depicted in FIG. 8 clearly shows rather large variations in attenuation, in particular at the lower band edge. Under these conditions, it is not desirable to switch to a modulation scheme higher than BPSK because the ISI will be too large to support this higher data rate. However, the DCS can be activated to move the HS carrier to a higher frequency. For example, when the HS carrier is moved to frequency 2413 MHz, better channel conditions are encountered. When again doing measurements, the channel response derived from the compensated RSSI values measured in slave C will be as shown in FIG. 9. Clearly, the channel is rather flat, and slave C can change the modulation scheme from BPSK to QPSK or even 8-PSK.

In some systems, it may be the case that not all of the slaves use the same HS carrier. Regardless of whether this is the case, if more than one slave is operating on the same HS carrier, yet other embodiments include DCS schemes running in the master A that take into account the measurements (and data rate requirements) from one or more of these other slaves (e.g., slave B) in addition to the information reported by slave C before the decision to move to another frequency is taken.

The discussion will now focus on receiver configurations for carrying out the various techniques described above. In a simple receiver configuration, the receiver either demodulates the wideband information signal, or carries out narrowband RSSI measurements. The receiver cannot do both at the same time. An exemplary receiver architecture for this case is shown in FIG. 10. A low noise amplifier (LNA) 1010 amplifies a received signal from an antenna 1005 and a mixer 1020 carries out the down-conversion step from radio frequency (RF) to intermediate frequency (IF) (low IF or even DC). These components may be used regardless of whether the receiver is performing wideband HS channel demodulation or the narrowband channel RSSI measurement or demodulation. A synthesizer 1030 determines the center frequency for either the wideband signal or the narrowband RSSI measurement or demodulation, depending on what mode the receiver is in. When taking RSSI measurements, the synthesizer 1030 is controlled to enable measurements of the various carrier frequencies (e.g., F₋₂, F₋₁, F₀, F₁, F₂ . . . ) in accordance with any of the techniques described earlier.

Two branches each receive the output from the mixer 1020: one narrowband branch with a narrowband (NB) filter 1040 (typically with a −3 dB bandwidth of 500 kHz for BLUETOOTH® FH mode) and one wideband branch with a wideband (WB) filter 1050 (typically with a −3 dB bandwidth of about 4 to 5 MHz for BLUETOOTH® HS mode). The output signals from the filters 1040, 1050 may either be fed directly into respective analog demodulators (like an FM discriminator for the BLUETOOTH® FH mode), or alternatively to respective analog-to-digital (A-to-D) converters 1048, 1054 which then supply digital signals to respective digital demodulators, which may have common re-configurable circuitry for the HS mode and the basic mode. In the figures, the A-to-D converters are depicted in dotted lines to represent the fact that the use of digital circuitry is optional.

For RSSI measurements, the signal does not have to be demodulated. Instead, power measurements can be taken directly in an RSSI detector 1080, which receives the downconverted signal in the NB path. The RSSI detector 1080 may also be implemented by means of analog circuitry or by some form of digital logic, in which case it either receives the output of the A-to-D converter 1048 which also supplies a signal to the NB demodulator 1060 (configuration not depicted in the figure), or alternatively has its own A-to-D converter 1044.

In alternative embodiments, a more advanced transceiver is used that has a receiver capable of performing narrowband measurements while at the same time receiving broadband data. In this case, a slave can measure on its own received data without relying on the transmission to another slave. A more advanced receiver architecture capable of such operation is shown in FIG. 11. The LNA 1010 may still be common between the NB and WB branches. Since the center frequencies of the HS channel may be different from the center frequency for the RSSI measurement, the branches split at the down-conversion stage. A synthesizer 1140 therefore supplies one local oscillator signal to a first mixer 1120 for the NB branch, and a different local oscillator signal to a second mixer 1130 for the WB branch. The output of the first mixer 1120 supplies a downconverted signal to the NB branch, while the output of the second mixer 1130 supplies a downconverted signal to the WB branch. Remaining components in the NB and WB branches are as described above with reference to FIG. 10, and are therefore not described again here.

FIG. 12 depicts an alternative embodiment of a transceiver capable of performing narrowband measurements while at the same time receiving broadband data. In this embodiment, a cascading approach is taken in which the received signal (supplied at the output of the LNA 1010) is initially down-converted using a first mixer 1220 to the IF for the wideband channel, and is subsequently up-converted or down-converted by a second mixer 1230 for the IF of the RSSI measurement. The output of the first mixer 1220 is supplied directly to the WB branch, and also to the input of the second mixer 1230. For this embodiment to work, a synthesizer 1240 still generates two different local oscillator signals, for respective use by the two mixers 1220, 1230, but the frequency of local oscillator signal that generates the IF of the RSSI measurement needs to be adjusted accordingly. Remaining components in this embodiment operate as earlier-described.

It will be understood that in addition to the channel response conditions, the interference conditions can also be taken into account while applying the DCS algorithm. It will also be understood that the unit scanning the HS channel with its narrowband receiver can only get an assessment of the (relative) channel amplitude because only RSSI can be measured. As the wideband signal cannot be decoded in receivers having architectures similar to that depicted in FIG. 10, the assessment cannot be based on BER or PER values.

The invention has been described with reference to particular embodiments. However, it will be readily apparent to those skilled in the art that it is possible to embody the invention in specific forms other than those of the embodiment described above. The described embodiments are merely illustrative and should not be considered restrictive in any way. The scope of the invention is given by the appended claims, rather than the preceding description, and all variations and equivalents which fall within the range of the claims are intended to be embraced therein.

What is claimed is:

1. A method of determining a channel response of a channel in a dual-mode radio communication system comprising:
detecting a wideband signal;
using a narrowband receiver to generate received signal strength measurements at frequencies located within a bandwidth of the wideband signal; and
using the received signal strength measurements as an indicator of the channel response of the channel.

2. The method of claim 1, comprising selecting a modulation scheme based on the indicator of the channel response of the channel.

3. The method of claim 2, wherein selecting the modulation scheme based on the indicator of the channel response of the channel is performed in a radio unit that performed detecting the wideband signal.

4. The method of claim 2, comprising:
communicating the received signal strength measurements to a radio unit that transmitted the wideband signal,
wherein selecting the modulation scheme based on the indicator of the channel response of the channel is performed in the radio unit that transmitted the wideband signal.

5. The method of claim 2, comprising:
in a radio unit that performed detecting the wideband signal, generating one or more parameters that represent a flatness of the wideband signal; and
communicating the one or more parameters that represent flatness of the wideband signal to a radio unit that transmitted the wideband signal,
wherein selecting the modulation scheme based on the indicator of the channel response of the channel is performed in the radio unit that transmitted the wideband signal.

6. The method of claim 1, comprising selecting an adjustment of a center frequency of the wideband signal based on the indicator of the channel response of the channel.

7. The method of claim 6, wherein selecting the adjustment of the center frequency of the wideband signal based on the indicator of the channel response of the channel is performed in a radio unit that performed detecting the wideband signal.

8. The method of claim 6, comprising:
communicating the indicator of the channel response of the channel to a radio unit that transmitted the wideband signal,
wherein selecting the adjustment of the center frequency of the wideband signal based on the indicator of the channel response of the channel is performed in the radio unit that transmitted the wideband signal.

9. The method of claim 1, comprising:
while using the narrowband receiver to generate received signal strength measurements at frequencies located within the bandwidth of the wideband signal, using a wideband receiver to demodulate the wideband signal.

10. The method of claim 1, wherein:
detecting the wideband signal is performed by a first radio unit; and
the wideband signal is intended for reception by a second radio unit.

11. The method of claim 1, wherein:
detecting the wideband signal is performed by a first radio unit; and
the wideband signal is intended for reception by the first radio unit.

12. An apparatus that determines a channel response of a channel in a dual-mode radio communication system comprising:
logic that detects a wideband signal;
logic that uses a narrowband receiver to generate received signal strength measurements at frequencies located within a bandwidth of the wideband signal; and
logic that uses the received signal strength measurements as an indicator of the channel response of the channel.

13. The apparatus of claim 12, comprising logic that selects a modulation scheme based on the indicator of the channel response of the channel.

14. The apparatus of claim 13, wherein the logic that selects the modulation scheme based on the indicator of the channel response of the channel is located in a radio unit that includes the logic that detects the wideband signal.

15. The apparatus of claim 12, comprising:
a wideband receiver that demodulates the wideband signal while the narrowband receiver generates received signal strength measurements at center frequencies located within the bandwidth of the wideband signal.

16. The apparatus of claim 12, wherein:
the apparatus is part of a first radio unit; and
the wideband signal is intended for reception by a second radio unit.

17. The apparatus of claim 12, wherein:
the apparatus is part of a first radio unit; and
the wideband signal is intended for reception by the first radio unit.

18. A system that determines a channel response of a channel in a dual-mode radio communication system comprising:
a first radio unit that transmits a wideband signal; and
a second radio unit that comprises:
logic that detects the wideband signal;
logic that uses a narrowband receiver to generate received signal strength measurements at frequencies located within a bandwidth of the wideband signal; and
logic that communicates information about the received signal strength measurements to the first radio unit,
wherein the information about the received signal strength measurements is indicative of a channel response of a channel between the first radio unit and the second radio unit.

19. The system of claim 18, wherein the first radio unit comprises logic that selects a modulation scheme based on the information about the received signal strength measurements.

20. The system of claim 18, wherein the information about the received signal strength measurements comprises one or more parameters that represent a flatness of the wideband signal.

21. The system of claim 20, wherein the first radio unit comprises logic that selects a modulation scheme based on the information about the received signal strength measurements.

22. The system of claim 18, wherein the first radio unit comprises logic that adjusts a center frequency of the wideband signal based on the information about the received signal strength measurements.

23. The system of claim 22, wherein the second radio unit is not the intended recipient of the wideband signal.

24. A system that determines a channel response of a channel in a dual-mode radio communication system comprising:
a first radio unit that transmits a wideband signal; and
a second radio unit that comprises:
logic that detects the wideband signal;
logic that uses a narrowband receiver to generate received signal strength measurements at center frequencies located within a bandwidth of the wideband signal;
logic that uses the received signal strength measurements to generate a desired adjustment of a center frequency of the wideband signal;
logic that communicates the desired adjustment of the center frequency of the wideband signal to the first radio unit.

25. The system of claim 24, wherein the first radio unit comprises logic that adjusts the center frequency of the wideband signal based on the desired adjustment to the center frequency of the wideband signal.
